(19) United States
(12) Patent Application Publication
(10) Pub. No.: US 2006/0215696 A1
(43) Pub. Date: Sep. 28, 2006

(54) Information processing device linkage apparatus, information processing device linkage system, and information processing device linkage program

(75) Inventors: Shigeki Fukuta, Kawasaki (JP); Takao Mohri, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/174,509

(22) Filed: Jul. 6, 2005

(30) Foreign Application Priority Data
Mar. 25, 2005 (JP) 2005-087647

(51) Int. Cl. H04J 3/16

(52) U.S. Cl. 370/469

(57) ABSTRACT

The present invention is made to provide an information processing device linkage system capable of assigning different roles to respective terminals in accordance with their characteristics and customizing screen and input in accordance with the characteristics. The information processing device linkage system comprises a plurality of terminals 20, 30 and a shared environmental server 10 that utilizes the plurality terminals simultaneously to perform role sharing. The server 10 comprises: a role table storage section 10c that stores, as a role table, information including role name, role selection condition, and role execution content that correspond to a role set; a role assigning section 10a that assigns roles to the terminals in accordance with their characteristics; and an output selection section 10e that performs output restriction for respective terminals in accordance with their roles. When the terminal issues a role sharing request, the role assigning section 10a lists the terminal for each set in the role table in accordance with respective roles in decreasing order of adequacy to create a recommended terminal list and transmits the recommended terminal list to the user terminal, as well as notifies the output selection section 10e of the content to be executed in accordance with the user's selection and further notifies the role sharing request sections 20b and 30b of the selected terminals of the contents to be executed.

### BACKGROUND OF THE INVENTION

1. Field of the Invention

The present invention relates to an information processing device linkage apparatus, an information processing device linkage system, and an information processing device linkage program for linking a plurality of information processing devices.

2. Description of the Related Art

As a system for sharing computing environment between a plurality of information processing devices, a remote meeting system that customizes transmitted information utilizing display capability of the terminals (refer to, for example, Patent Document 1: Jpn. Pat. Appln. Laid-Open Publication No. 2-2794) is available. The system disclosed in the above publication cuts out a specified part of a display screen and enlarges/reduces it in accordance with the terminal with low-display capability.

Further, a video conference support system that has established a video conference connection in consideration of presence of users and terminals that includes position information is available (refer to, for example, Patent Document 2: Jpn. Pat. Appln. Laid-Open Publication No. 2002-252839).

Further, an electronic conferencing system is available (refer to, for example, Patent Document 3: Jpn. Pat. Appln. Laid-Open Publication No. 7-79288). In the electronic conferencing system of the above publication, terminals transmit data without modification or transmit data after converting it into an image at the data transmission time and display the image in a reduced size in accordance with terminal's own display area at the data reception time.

However, the abovementioned remote meeting system disclosed in Publication No. 2-2794 only cuts out or enlarges/reduces a display screen, and nothing has been disclosed about sharing of a plurality of applications and customization for each application.

Further, in the abovementioned video conference support system disclosed in Publication No. 2002-252839, nothing has been disclosed about customization of a display function.

Further, the abovementioned electronic conferencing system disclosed in Publication No. 7-79288, nothing has been disclosed about sharing of a plurality of applications and customization of a plurality of streams performed in accordance with a reception side terminal.

### SUMMARY OF THE INVENTION

The present invention has been made in view of the above point, and an object thereof is to provide an information processing device linkage apparatus, an information processing device linkage system, and an information processing device linkage program capable of assigning a plurality of roles to respective terminals in accordance with characteristics thereof and customizing outputs of the terminals.

To solve the above problem, according to a first aspect of the present invention, there is provided an information processing device linkage apparatus that utilizes a plurality of different terminals simultaneously to perform role sharing, comprising: a role information acquisition section that acquires information related to a role that the terminal can take on; and a role assigning section that assigns a combination of terminals to a predetermined role based on the information related to the role acquired by the role information acquisition section.

The information processing device linkage apparatus further comprises an output selection section that performs output restriction for respective terminals, to which the predetermined roles have been assigned by the role assigning section, in accordance with the assigned roles.

The role assigning section presents, as candidates, a combination of terminals to a user and assigns a role to a combination of terminals selected by the user.

The role assigning section provides the priority for each candidate of the terminal combination to be presented to the user.

The role information acquisition section includes a role table storage section that sores the information related to a role as a role table, and the role assigning section lists the terminals that suit the respective roles based on a role sharing request from an arbitrary user terminal to create a recommended terminal list and allows the user to select the terminals that take on the respective roles from the recommended terminal list.

The role information acquisition section includes the role table storage section that stores, as the role table, information including at least one of role name, role selection condition, and role execution content that correspond to a role set, and the role assigning section lists the terminal for each set in the role table stored in the role table storage section based on a role sharing request from an arbitrary user terminal to create the recommended terminal list and transmits the recommended terminal list to the user terminal, as well as notifies the output selection section of the content to be executed in accordance with the user's selection.

The information processing device linkage apparatus further comprises a terminal characteristics table storage section that stores, as a terminal characteristics table, information including at least one of screen characteristics, input device, portability, credibility, and compatibility to ancillary application that correspond to a terminal ID, wherein the role assigning section selects one set from the role table stored in the role table storage section, selects one role from the selected set in the role table, selects one terminal from the terminal characteristics table stored in the terminal characteristics table storage section, determines whether the selected terminal meets the role selection condition, calculates the priority of the terminal based on the weighting set in the selection condition of the selected role when the selected terminal meets the role selection condition, sorts the terminal list in the descending order of adequacy so as to add the terminals to the recommended terminal list, and transmits the recommended terminal list to the terminal that has issued the role sharing request.

According to a second aspect of the present invention, there is provided an information processing device linkage system comprising a plurality of different terminals and a shared environmental server that utilizes the plurality of terminals simultaneously to perform role sharing, wherein the shared environmental server comprises: a role information acquisition section that acquires information related to a role that the terminal can take on; a role assigning section that assigns a combination of terminals to a predetermined role based on the information related to the role acquired by the role information acquisition section; and an output selection section that performs output restriction for respective terminals, to which the predetermined roles have been assigned by the role assigning section, in accordance with the assigned roles, and each of the plurality of terminals comprises: a role sharing request section that plays the assigned role based on an instruction from the role assigning section; and a display section that displays a restricted output from the output selection section.

According to a third aspect of the present invention, there is provided an information processing device linkage program allowing a computer to execute an information processing device linkage method that utilizes a plurality of different terminals simultaneously to perform role sharing, comprising: a role information acquisition step that acquires information related to a role that the terminal can take on; and a role assigning step that assigns a combination of terminals to a predetermined role based on the information related to the role acquired in the role information acquisition step.

The information processing device linkage program further allows the computer to execute an output selection step that performs output restriction for respective terminals, to which the predetermined roles have been assigned in the role assigning step, in accordance with the assigned roles.

The role assigning step presents, as candidates, a combination of terminals to a user and assigns a role to a combination of terminals selected by the user.

The role assigning step provides the priority for each candidate of the terminal combination to be presented to the user.

The role information acquisition step acquires role information from a role table storage section that sores the information related to a role as a role table, and the role assigning step lists the terminals that suit the respective roles based on a role sharing request from an arbitrary user terminal to create a recommended terminal list and allows the user to select the terminals that take on the respective roles from the recommended terminal list.

The role information acquisition step acquires the role information from the role table storage section that stores, as the role table, information including at least one of role name, role selection condition, and role execution content that correspond to a role set, and the role assigning step lists the terminal for each set in the role table stored in the role table storage section based on a role sharing request from an arbitrary user terminal in accordance with respective roles in decreasing order of adequacy to create the recommended terminal list and transmits the recommended terminal list to the user terminal, as well as notifies the output selection section of the content to be executed in accordance with the user's selection.

The information processing device linkage program further comprises a terminal characteristics selection acquisition step that selectively acquires terminal characteristics from a terminal characteristics table storage section that stores, as a terminal characteristics table, information including at least one of screen characteristics, input device, portability, credibility, and compatibility to ancillary application that correspond to a terminal ID, wherein the role assigning step selects one set from the role table stored in the role information acquisition step, selects one role from the selected set in the role table, selects one terminal from the terminal characteristics table stored in the terminal characteristics table storage section by the terminal characteristics selection acquisition step, determines whether the selected terminal meets the role selection condition, calculates the priority of the terminal based on the weighting set in the selection condition of the selected role when the selected terminal meets the role selection condition, sorts the terminal list in the descending order of adequacy so as to add the terminals to the recommended terminal list, and transmits the recommended terminal list to the terminal that has issued the role sharing request.

According to the present invention, it is possible to assigning different roles to respective terminals in accordance with the characteristics of the terminals and to customize the screen and input in accordance with the characteristics.

### BRIEF DESCRIPTION OF THE DRAWINGS

FIG. 1 is a view for explaining the concept of an information processing device linkage system according to the present invention;

FIG. 2 is a block diagram showing a system configuration of the information processing device linkage system according to the present invention;

FIGS. 3A to 3C show an application characteristics table, a role table, and a terminal characteristics table stored in an application characteristics table storage section 10b, a role table storage section 10c, and a terminal characteristics table storage section 10d, respectively;

FIG. 4 is a view showing main flows of a role assigning operation in the information processing device linkage system shown in FIG. 2;

FIG. 5 is a view showing main flows of a terminal confirming operation in the information processing device linkage system shown in FIG. 2;

FIG. 6 is a view for explaining the outline of a remote controller operation in the information processing device linkage system shown in FIG. 2;

FIG. 7 is a view for explaining the outline of a concrete example of the remote controller operation subsequent to FIG. 6;

FIG. 8 is a view for explaining a concrete step of the remote controller operation in the information processing device linkage system shown in FIG. 2;

FIG. 9 is a view for explaining a step subsequent to that of FIG. 8;

FIG. 10 is a view for explaining a step subsequent to that of FIG. 9;

FIG. 11 is a view for explaining a step subsequent to that of FIG. 10;

FIG. 12 is a view for explaining a step subsequent to that of FIG. 11;

FIG. 13 is a view for explaining a step subsequent to that of FIG. 12;

FIG. 14 is an explanation view of a recommended terminal list created by a role assigning section 10a of a shared environmental server 10 shown in FIG. 2;

FIG. 15 is a view showing an example of a terminal screen presented on a terminal at the terminal confirming operation;

FIG. 16 is a view for explaining the outline of a snapshot display operation in the information processing device linkage system shown in FIG. 2;

FIG. 17 is a view for explaining a concrete step of the snapshot display operation in the information processing device linkage system shown in FIG. 2;

FIG. 18 is a view for explaining a step subsequent to that of FIG. 17;

FIG. 19 is a view for explaining a step subsequent to that of FIG. 18;

FIG. 20 is a flowchart showing the content of a role assigning work performed by the role assigning section 10a of the shared environmental server 10 in the information processing device linkage system shown in FIG. 2;

FIG. 21 is a flowchart showing the content of a role assigning request made by a role assigning request section 20b of a request terminal 20 in the information processing device linkage system shown in FIG. 2; and

FIG. 22 is a flowchart showing the content of a terminal list arranged in decreasing order of adequacy created by the role assigning section 10a of the shared environmental server 10 in the information processing device linkage system shown in FIG. 2.

### DETAILED DESCRIPTION OF THE PREFERRED EMBODIMENTS

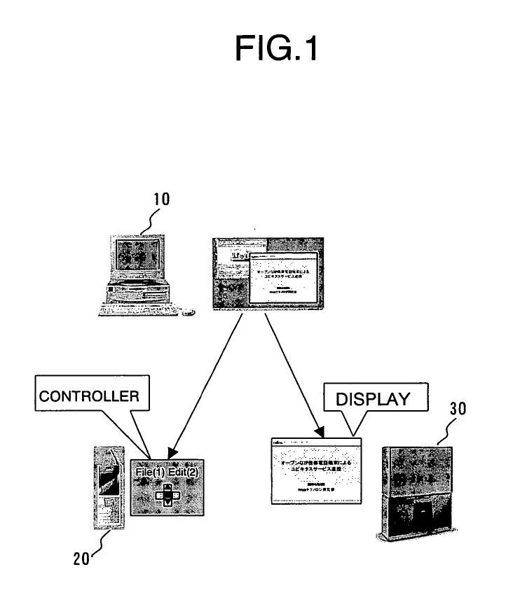

FIG. 1 is a view for explaining the concept of an information processing device linkage system according to the present invention. As shown in FIG. 1, the environment realized by the present invention includes, as an information processing device, a shared environmental server 10, and terminals 20, 30. In this environment, various roles are assigned to respective terminals in accordance with the characteristics thereof to customize the screen and input of the terminals in accordance with the characteristics. For example, the terminal 20 is allowed to function as a controller or an ordinary screen, and terminal 30 is allowed to function as a shared display or a fixed screen. Note that the shared environmental server 10 constitutes the information processing device linkage apparatus according to the present invention.

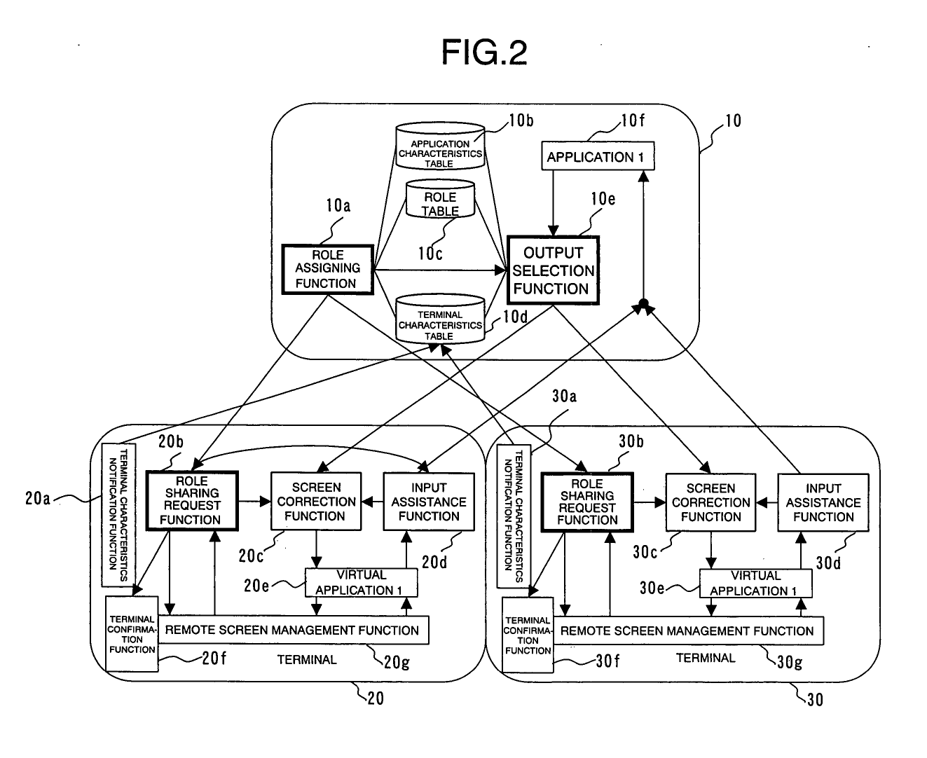

FIG. 2 is a block diagram showing a system configuration of the information processing device linkage system according to the present invention.

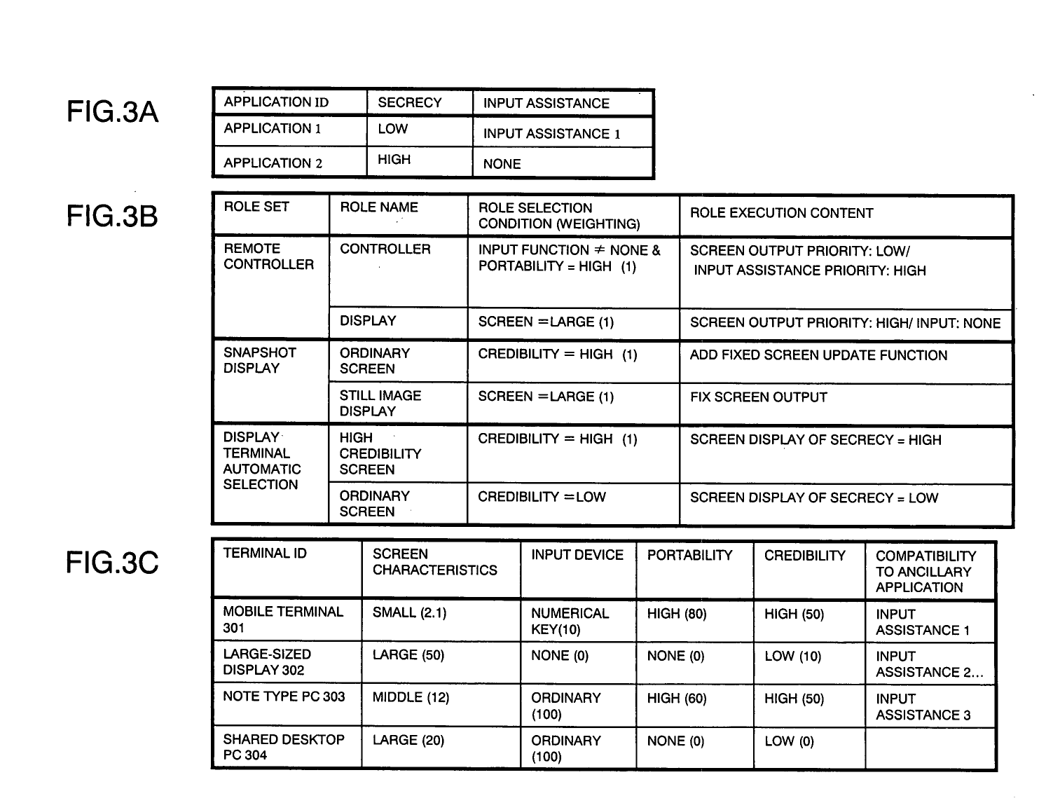

In the information processing device linkage system according to the present invention shown in FIG. 2, the shared environmental server 10 includes: a role assigning section 10a which assigns various roles to the terminals in accordance with terminal characteristics; an application characteristics table storage section 10b which stores, as shown in FIG. 3A, an application characteristics table listing information related to secrecy and input assistance set in accordance with application ID; a role table storage section 10c which stores, as shown in FIG. 3B, a role table listing information related to role name, role selection condition and role execution content set in accordance with role set; a terminal characteristics table storage section 10d which stores, as shown in FIG. 3C, a terminal characteristics table listing information related to screen characteristics, input device, portability, credibility, compatibility to ancillary application set in accordance with terminal ID; an output selection section 10e which restricts, for each terminal, the screen output in accordance with the role thereof; and an application 10f. The role assigning section 10a and output selection section 10e constitute an information processing device linkage program that a computer executes.

The terminals 20 and 30 have the same configuration. For example, the terminal 20 includes a terminal characteristics notification section 20a, a role sharing request section 20b, a screen correction section 20c, an input assistance section 20d, a virtual application 20e, a terminal confirmation section 20f, and a remote screen management section 20g. The role sharing request section 20b of the terminal 20 serving as a controller mediates between the server and user or the server and functions in the terminal and performs the adjustment between them. The screen correction section 30c and input assistance section 30d of the terminal 30 serving as a shared display correct the screens and functions of the respective terminals.

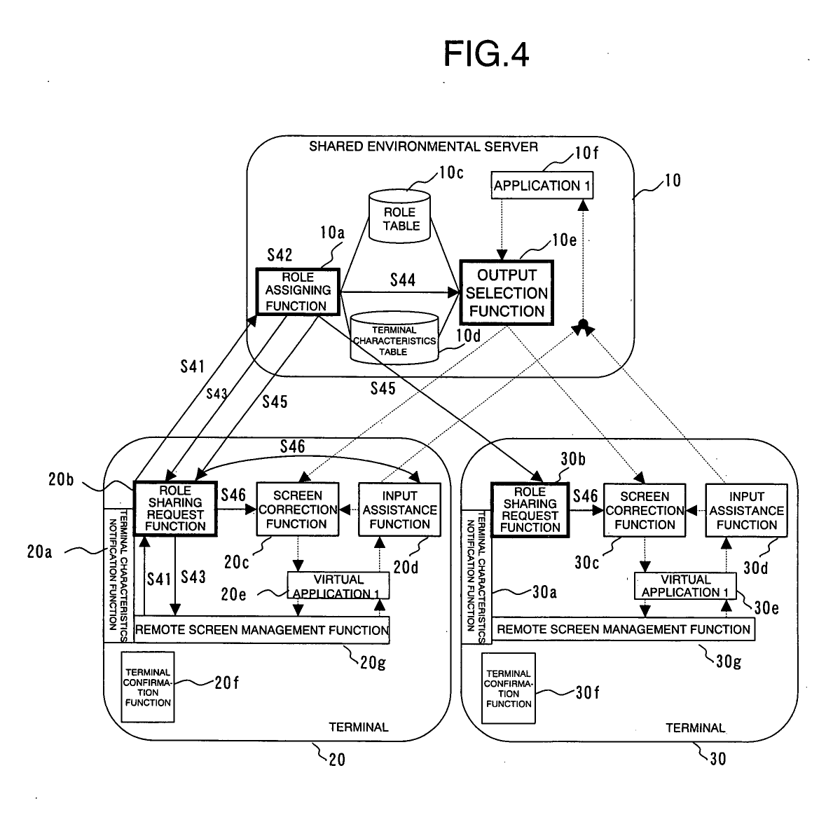

Next, main flows of the role assigning operation will be described with reference to FIG. 4.

Roles are firstly shared based on a user's instruction (S41). More concretely, the remote screen management section 20g of the terminal 20 instructs, through the role sharing request section 20b, the role assigning section 10a of the shared environmental server 10 to share roles. In response to the instruction, the role assigning section 10a performs a role assigning operation to assign terminals to each role (S42) and presents the set role assignation to the remote screen management section 20g through the role sharing request section 20b of the terminal 20 for confirmation of the role assignation (S43). The role assigning section 10a of the shared environmental server 10 notifies the output selection section 10e of the execution contents (S44), as well as notifies the role sharing request sections 20b and 30b of the terminals 20 and 30 of the execution contents (S45). The role sharing request section 20b of the terminal 20 serving as a controller correspondingly notifies the screen correction section 20c and input assistance section 20d of the execution contents and, at the same time, the role sharing request section 30b of the terminal 30 serving as a shared display notifies the screen correction section 30c of the execution content (S46).

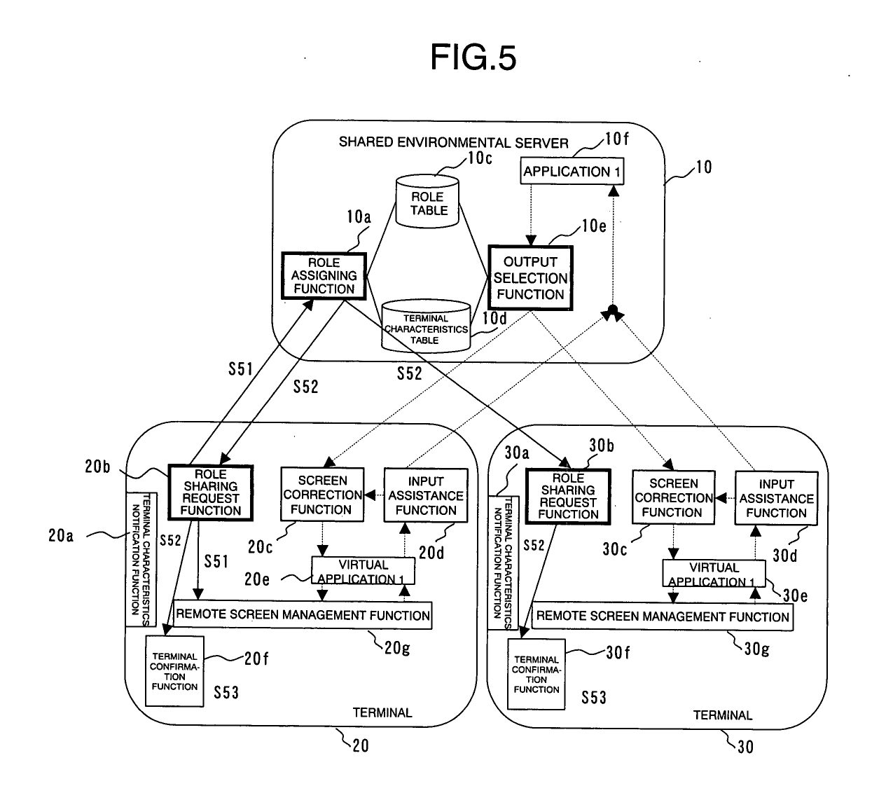

Main flows of the terminal confirmation operation will be described below with reference to FIG. 5.

The user firstly depresses a confirmation button in the assigning list (S51). The button depressing information is notified from the role sharing request section 20b of the terminal 20 to the role assigning section 10a of the shared environmental server 10. The information is then notified from the role assigning section 10a of the shared environmental server 10 to the terminal confirmation sections 20f and 30f through the role sharing request sections 20b and 30b of the selected terminals (S52). In response to the information, the terminal confirmation sections 20f and 30f perform a notification to the users by means of a screen display, LED, or voice output (S53).

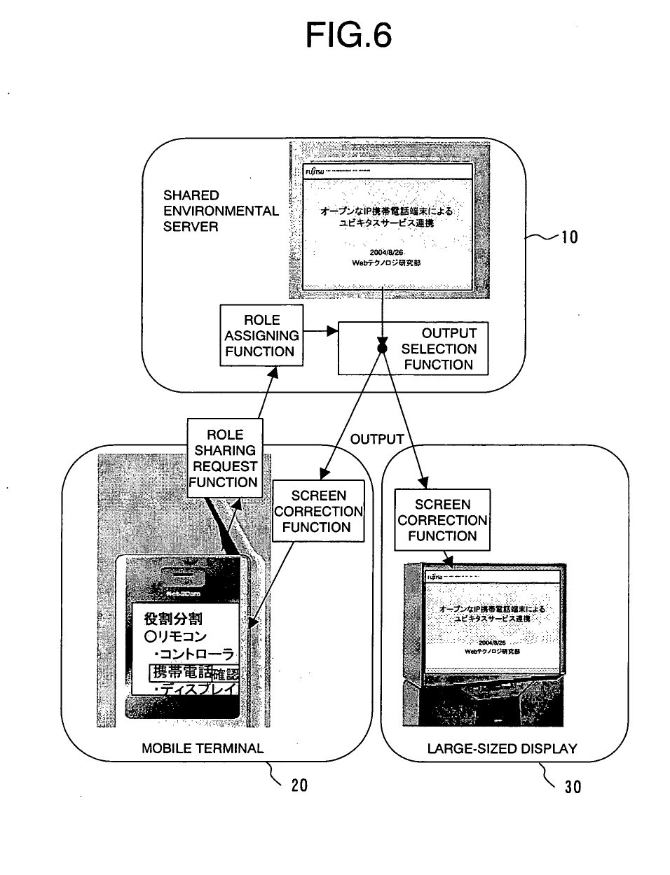

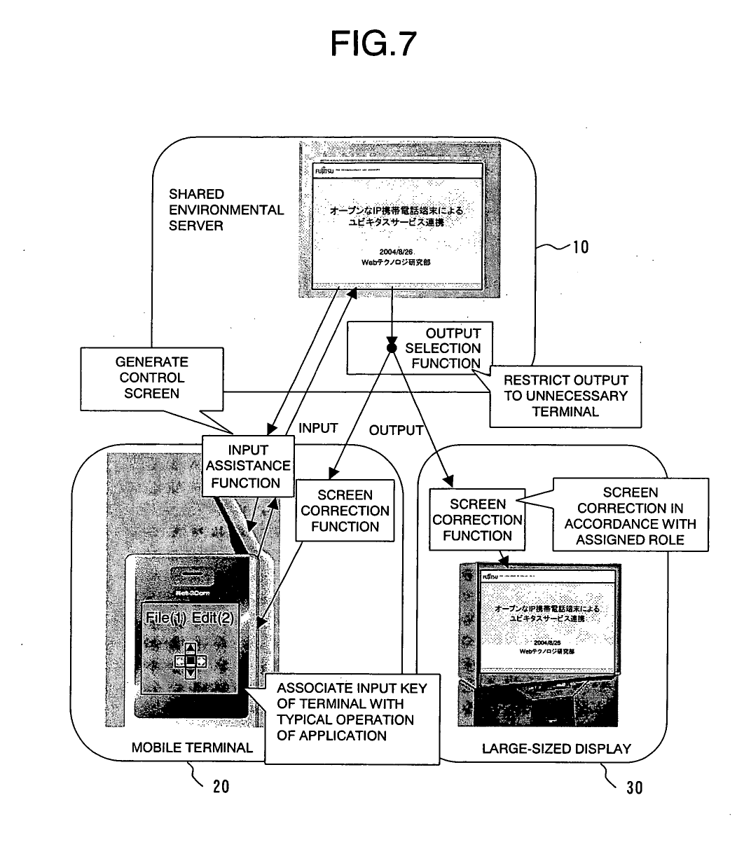

Next, a concrete operation of a remote controller will be described with reference to FIGS. 6 and 7.

FIG. 6 is a view for explaining the former part of the remote controller operation. The user firstly activates a role sharing request GUI (Graphical User Interface) on one terminal and depresses a sharing start button. The user then performs a selection from the presented list and confirmation. When, for example, selecting “remote controller” as selection 1, he or she selects the terminal 20, which is a mobile phone, as a controller and selects the terminal 30, which is a large-sized display, as a display. When selecting “snapshot” as selection 2, he or she selects the terminal 20 (mobile phone) as an ordinary screen and selects the terminal 30 (large-sized display) as a fixed screen. Further, a confirmation button is provided on the terminals in the list. When the user confirms the selected terminal and depresses the confirmation button, the ID or icon of the selected terminal is displayed on the screen. In the case of a device on which the confirmation signal cannot be displayed, a voice, actuator, or LED is used for the confirmation.

FIG. 7 is a view for explaining the latter part of the remote controller operation. Based on the flows shown in FIG. 6, the operations of respective terminals are changed according to the assigned roles. For example, a controller screen is generated, a display is maximized on the terminal 30 as a large-sized display, and the content of the large-sized display is changed according to the user's instruction.

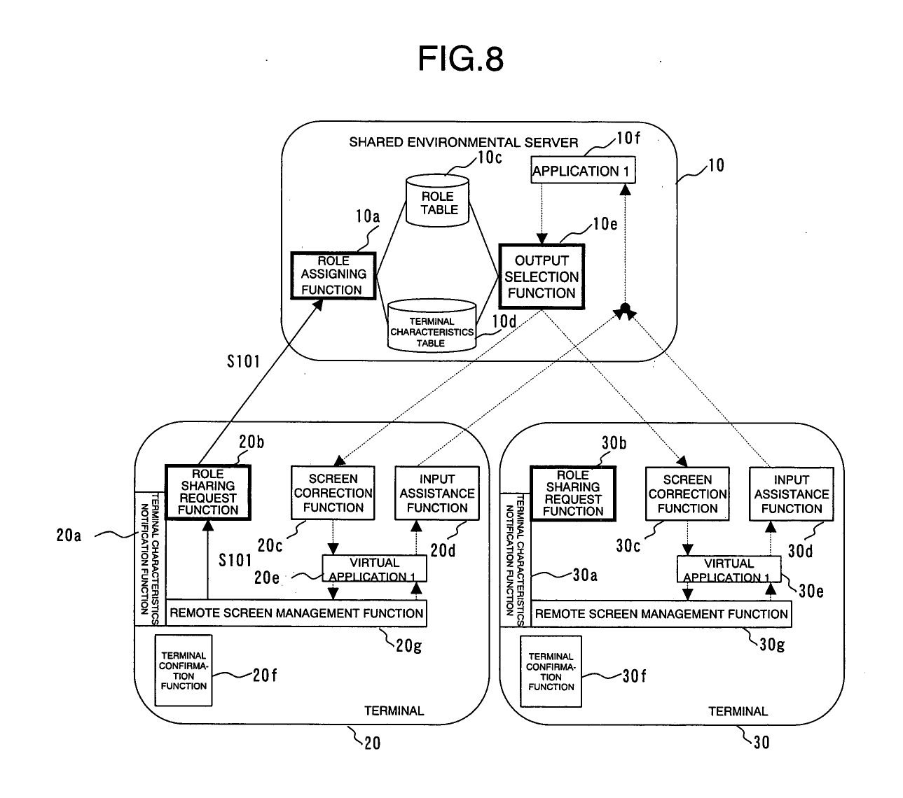

A concrete operation of the remote controller will be described below with reference to FIGS. 8 to 13.

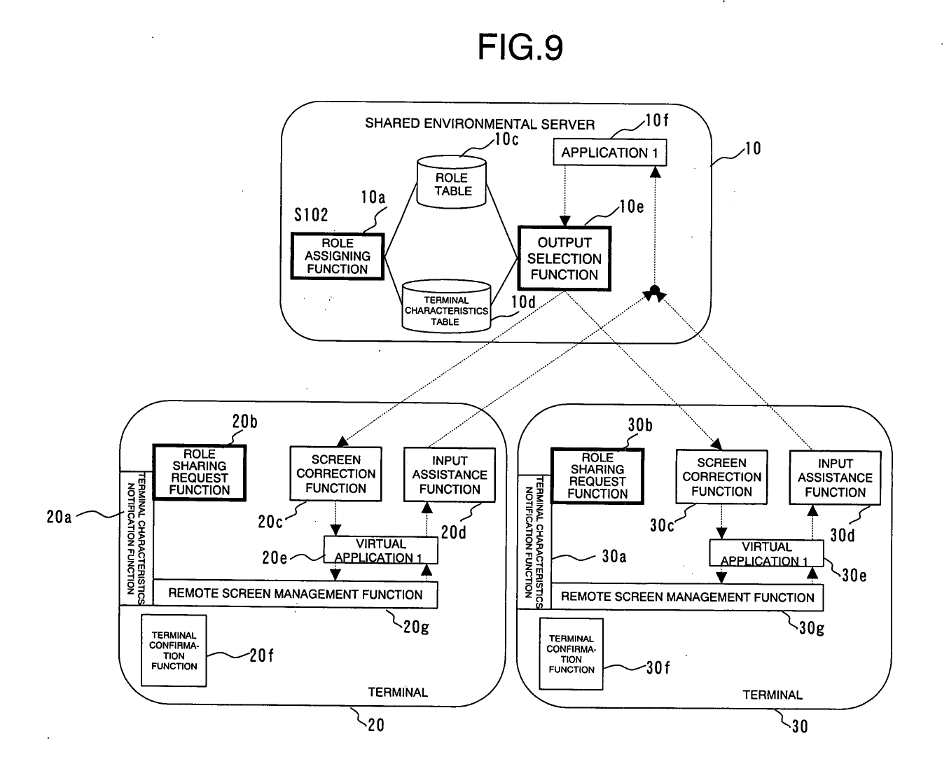

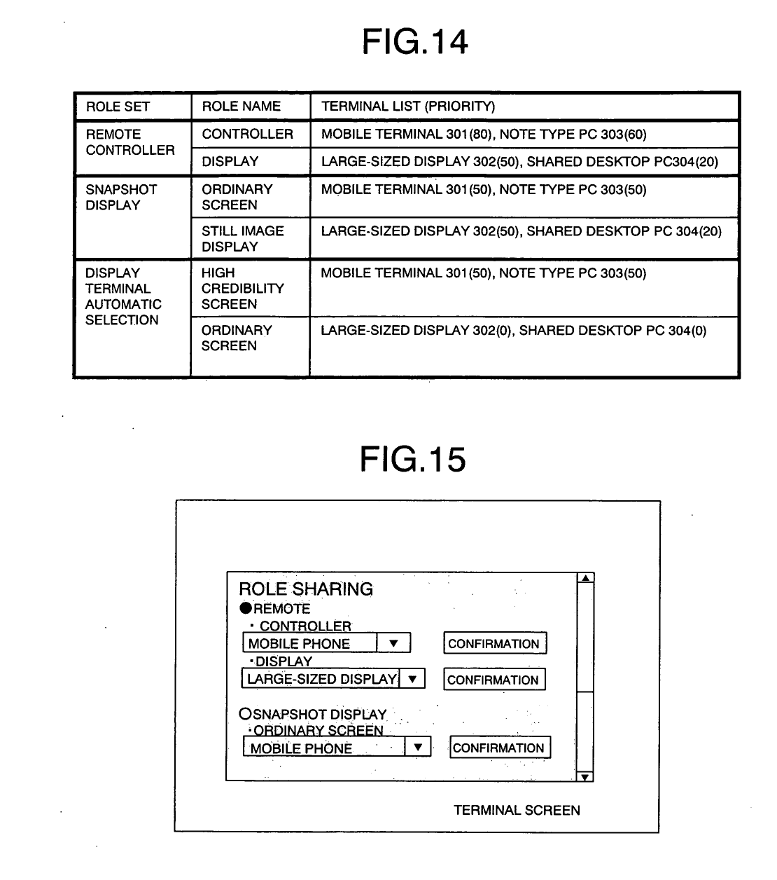

Firstly, in a state where the terminals display the same screen, the user activates the role sharing request GUI and depresses the sharing start button. That is, as shown in FIG. 8, a start message of the sharing is transmitted from the remote screen management section 20g of the terminal 20 through the role sharing request section 20b thereof to the role assigning section 10a of the shared environmental server 10 (S101). As shown in FIG. 9, upon receiving the start message, the role assigning section 10a of the shared environmental server 10 performs a priority calculation based on the role table stored in the role table storage section 10c and terminal characteristics table stored in the terminal characteristics table storage section 10d to create a recommended terminal list shown in FIG. 14 (S102). The recommended terminal list stores role name and terminal list corresponding to role set.

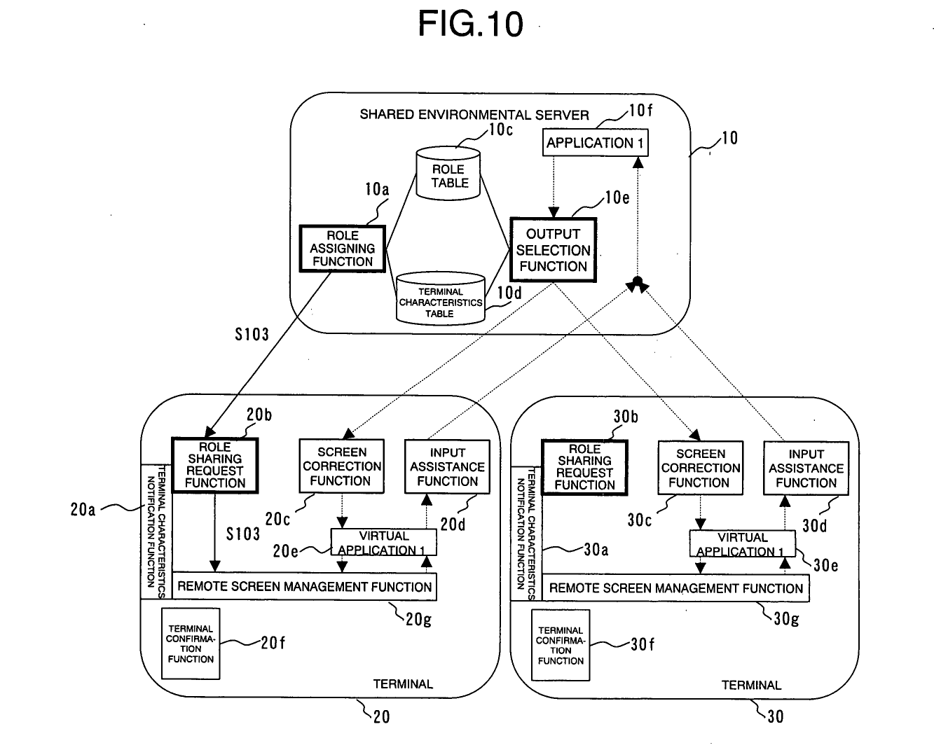

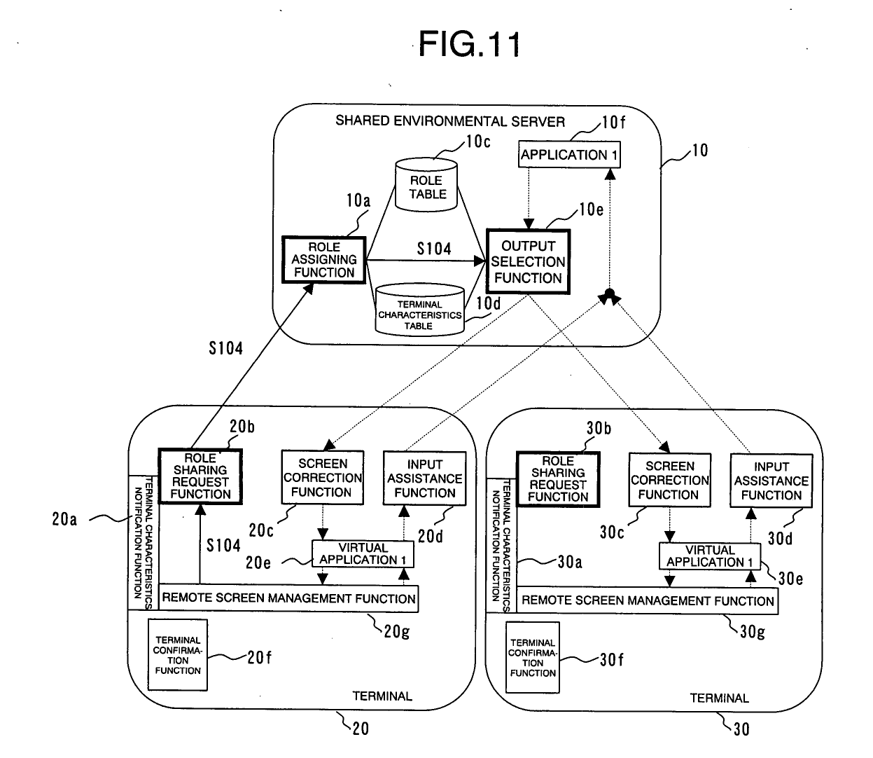

After that, as shown in FIG. 10, the role assigning section 10a of the shared environmental server 10 notifies the terminal 20 to which the role assigning section 10a has transmitted the start message in step S101 of the list created in step S102, and the role sharing request section 20b of the terminal 20 presents the list to the remote screen management section 20g (S103). Specifically, the screen as shown in FIG. 15 is presented. The user then selects a combination that meets his or her needs from the list that the remote screen management section 20g displays on the terminal screen example as shown in FIG. 15 and depress an execution button, as shown in FIG. 11. For example, the user sets the terminal 20 as a controller and terminal 30 as a display. The terminal 20 notifies the role assigning section 10a in the shared environmental server 10 of the user's selection. The role assigning section 10a in the shared environmental server 10 then notifies the output selection section 10e of the content to be processed (S104). The output from the application 10f to the terminal 20 is correspondingly stopped.

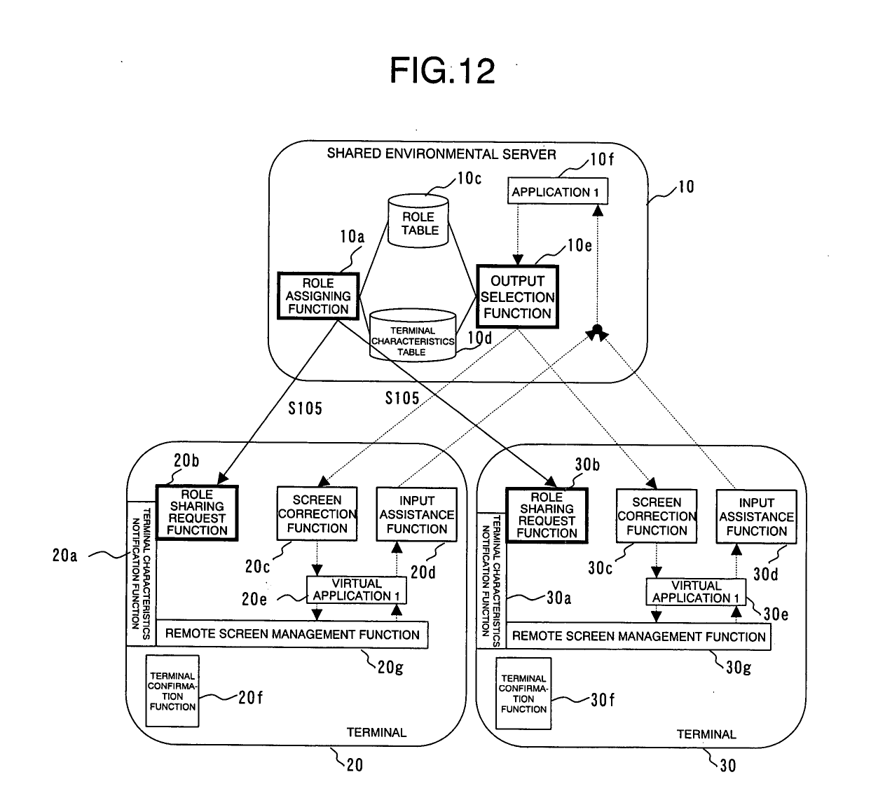

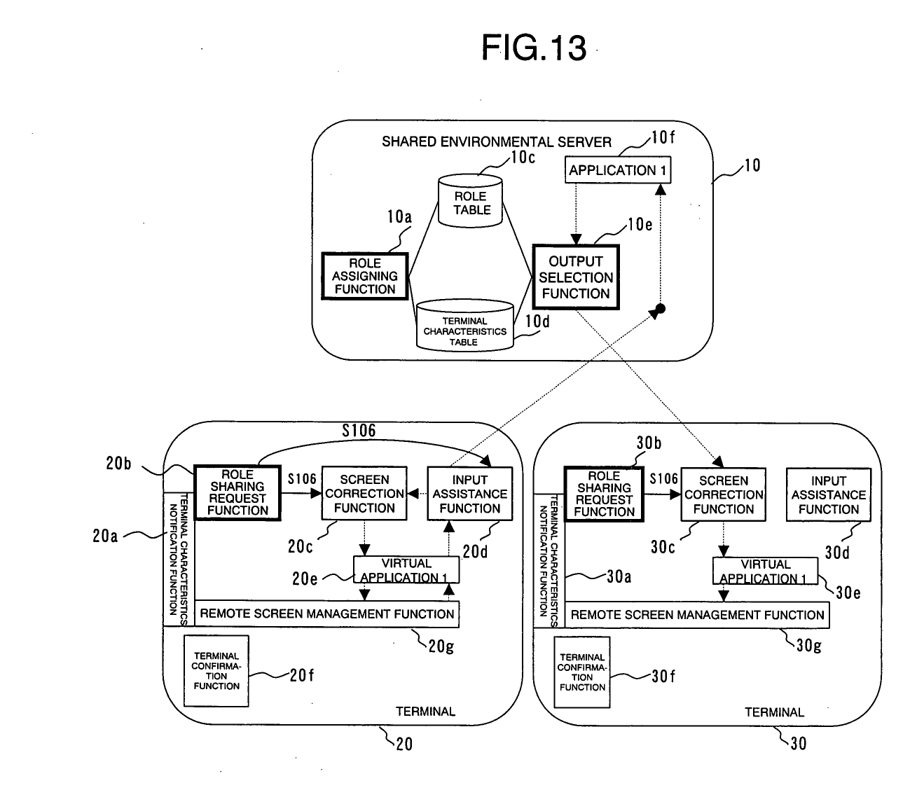

As shown in FIG. 12, the role assigning section 10a of the shared environmental server 10 notifies the role sharing request sections 20b and 30b of the selected terminals 20 and 30 of the processes to be executed, respectively (S105). In this case, the notifications to the role sharing request sections 20b and 30b of the selected terminals 20 and 30 are made such that the terminals 20 and 30 are set as a controller and a display, respectively. Then, as shown in FIG. 13, the role sharing request section 20b of the terminal 20 performs the notification to the screen correction section 20c and input assistance section 20d to stop drawing of the screen output from the shared environmental server 10 and activates the input assistance section 20d to display a controller screen. At the same time, the role sharing request section 30b of the terminal 30 performs the notification to the screen correction section 30c to display the screen output from the shared environmental server 10 in full size and stops an input transmission (S106).

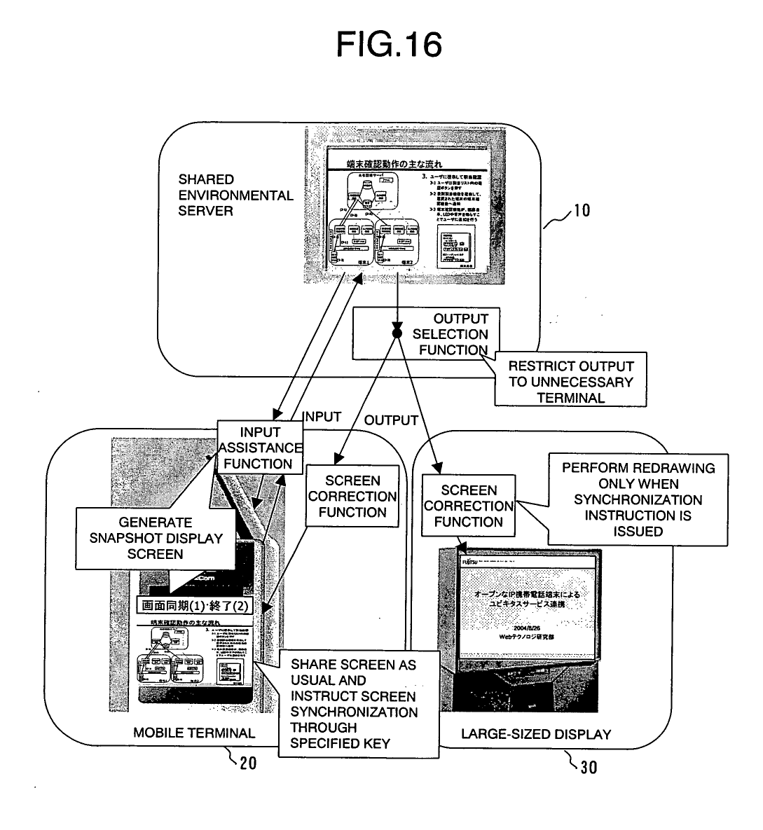

Next, a concrete operation of the snapshot display will be described with reference to FIG. 16.

FIG. 16 shows the latter part of the snapshot display operation. The former part thereof is the same as that of the remote controller operation, and description thereof will be omitted. In the latter part of the snapshot operation, each terminal changes its operation according to the assigned role. For example, the terminal 20 as a mobile terminal displays a snapshot operation panel, and the terminal 30 as a large-sized display maximizes a display area. The user performs a specified input operation displayed on the operation panel of the ordinary screen to start or end screen synchronization.

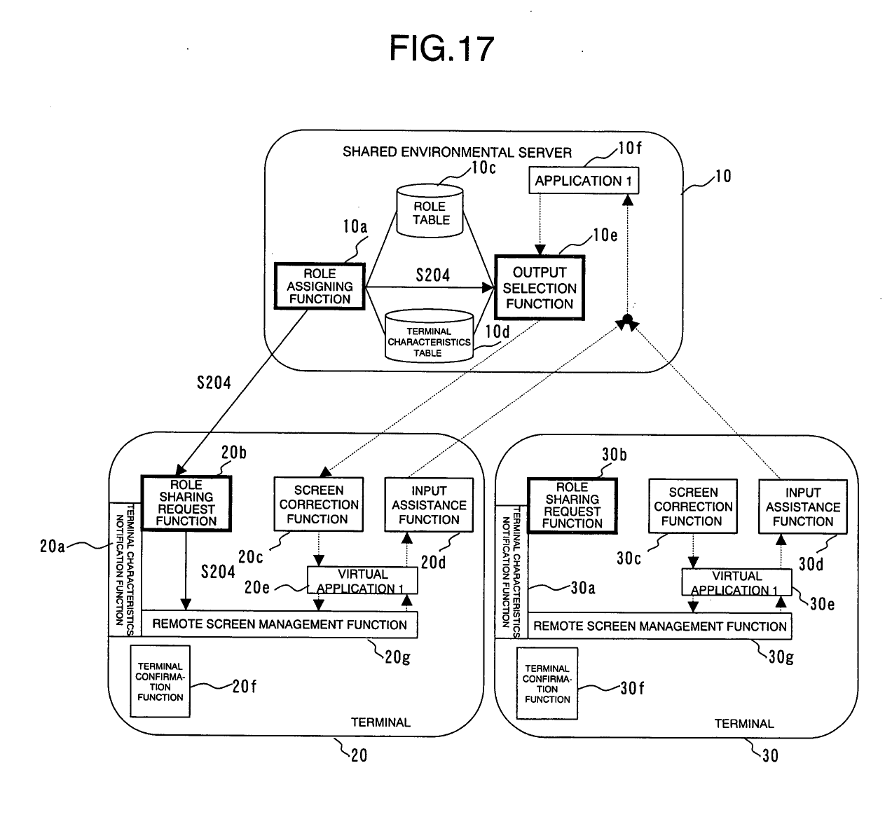

A concrete snapshot display operation will be described below with reference to FIGS.17 to 19.

Like the remote controller operation, the processes in steps S101 to S103 shown in FIGS. 8 to 10 are carried out in the snapshot display operation. Thereafter, as shown in FIG. 17, the user selects a combination that meets his or her needs from the list that the remote screen management section 20g displays on the terminal screen example as shown in FIG. 15 and depresses an execution button. For example, the user sets the terminal 20 as an ordinary screen and the terminal 30 as a still image display screen. The terminal 20 notifies the role assigning section 10a in the shared environmental server 10 of the user's selection. The role assigning section 10a in the shared environmental server 10 then notifies the output selection section 10e of the content to be processed (S204). The output from the application 10f to the terminal 20 is correspondingly stopped, and input from the terminal 30 to the application 10f is stopped.

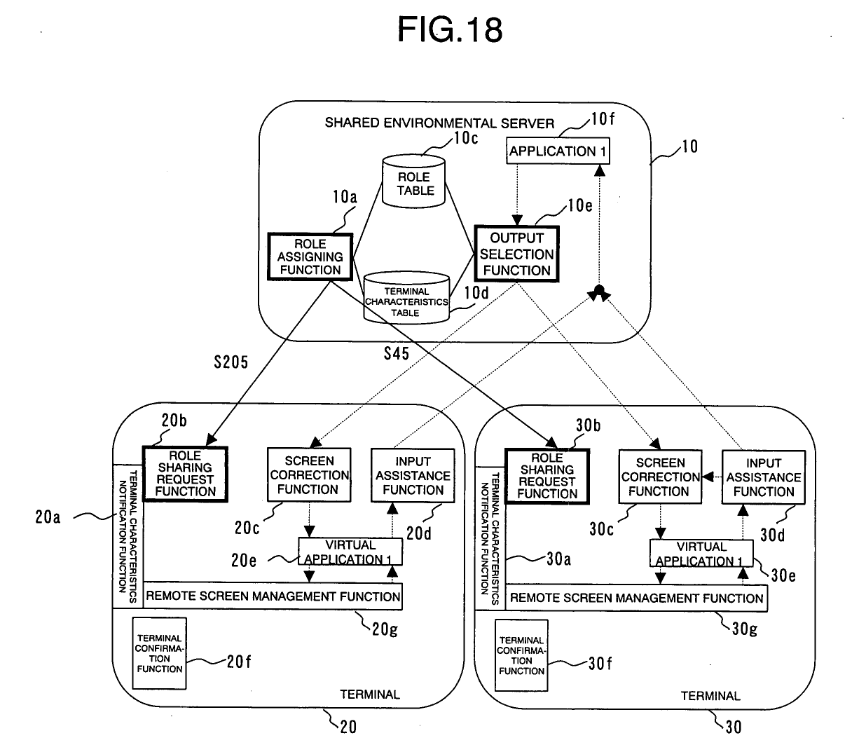

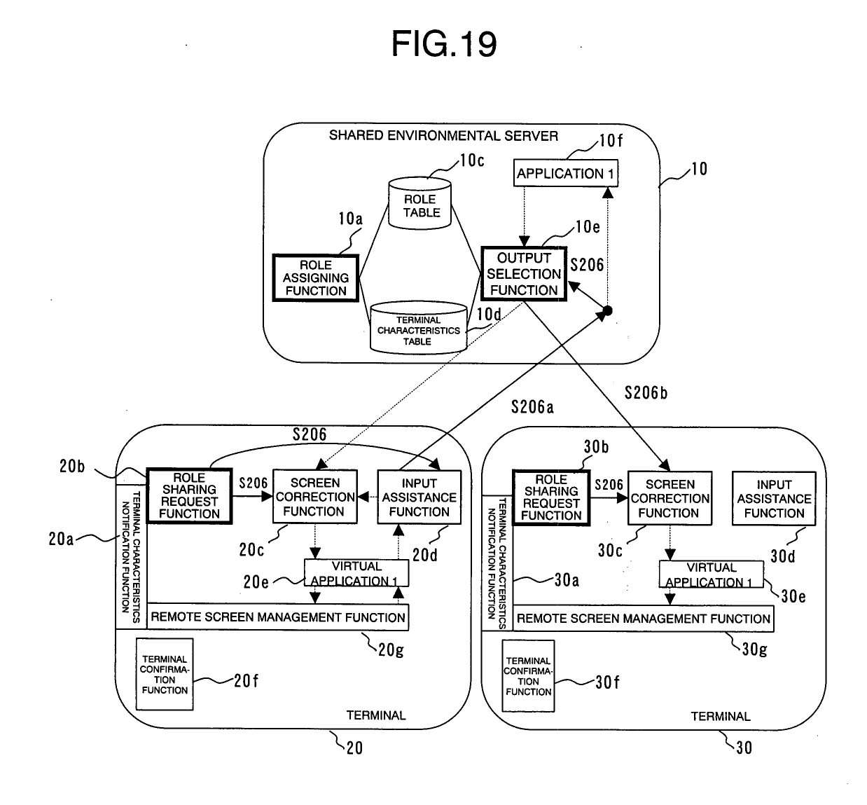

Further, as shown in FIG. 18, the role assigning section 10a of the shared environmental server 10 notifies the role sharing request sections 20b and 30b of the selected terminals 20 and 30 of the processes to be executed, respectively (S205). In this case, the notifications to the role sharing request sections 20b and 30b of the selected terminals 20 and 30 are made such that the terminals 20 and 30 are set as an ordinary screen and a still image display screen, respectively. Then, as shown in FIG. 19, the role sharing request section 20b of the terminal 20 performs the notification to the screen correction section 20c and input assistance section 20d and, at the same time, the role sharing request section 30b of the terminal 30 performs the notification to the screen correction section 30c (S206). In the terminal 20, the input assistance section 20d is activated to display a screen synchronization button. Only when the screen synchronization button is depressed, the latest screen information is transmitted, through the output selection section 10e of the shared environmental server 10, to the screen correction section 30c of the terminal 30 (S206a). When receiving the screen information from the shared environmental server 10, the terminal 30 updates the screen display with the latest screen information (S206b).

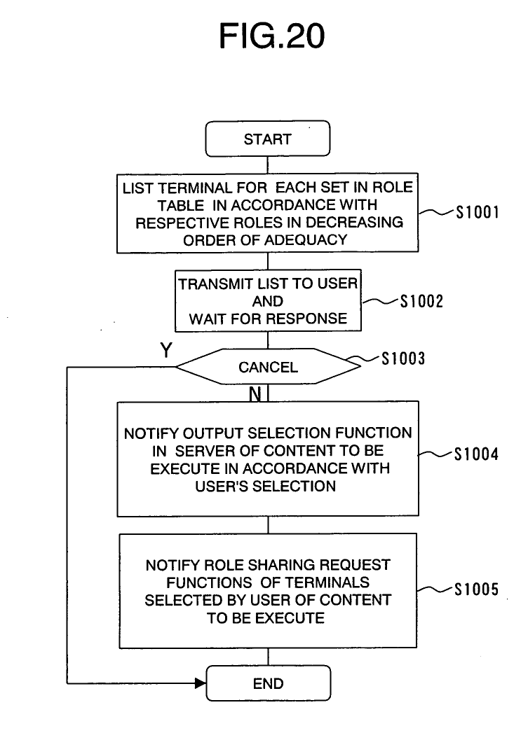

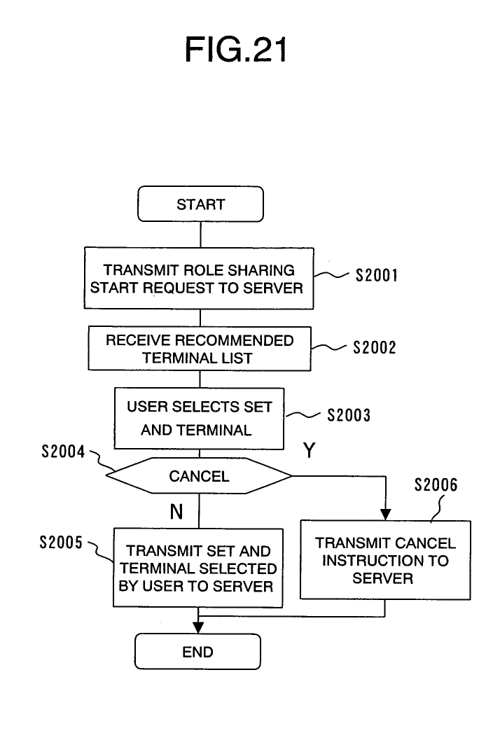

Next, details of a role sharing work in the above embodiment will be described with reference to flowcharts shown in FIGS. 20 and 21.

FIG. 20 is a flowchart showing the processes performed by the role assigning section 10a of the shared environmental server 10. As shown in FIG. 20, the role assigning section 10a in the shared environmental server 10 lists, for each set in the role table shown in FIG. 3B, the terminals in accordance with respective roles in decreasing order of adequacy to create the recommended terminal list shown in FIG. 14 (S1001). The role assigning section 10a then transmits the list to the user and waits for a response (Si 002). Unless the user cancels the operation, (No in S1003), the role assigning section 10a notifies the output selection section 10e in the shared environmental server 10 of content to be executed in accordance with the user's selection (S1004) and notifies the respective role sharing request sections of the selected terminals of the contents to be executed (S1005) and ends this flow.

FIG. 21 is a flowchart showing the processes performed by the role sharing request section 20b of the request terminal 20. As shown in FIG. 21, the role sharing request section 20b of the terminal 20 transmits a role sharing start request to the shared environmental server 10 (S2001) and correspondingly receives the recommended terminal list from the shared environmental server 10 (S2002). The user then selects the set and terminal (S2003). Unless the operation is canceled (No in S2004), the role sharing request section 20b transmits the set and terminal selected by the user to the shared environmental server 10 (S2005). If the operation is canceled, the role sharing request section 20b transmits a cancel instruction to the shared environmental server 10 (S2006).

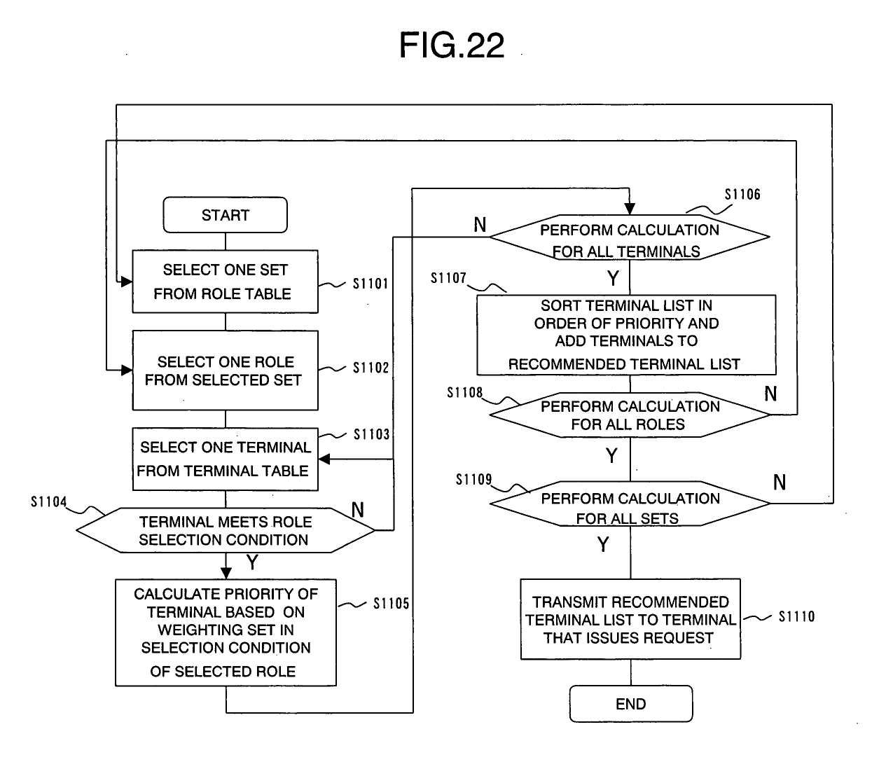

FIG. 22 is a flowchart showing creation process of the terminal list arranged in decreasing order of adequacy performed in step S1001 of FIG. 20 by the role assigning section 10a of the shared environmental server 10. As shown in FIG. 22, the role assigning section 10a of the shared environmental server 10 selects one set from the role table shown in FIG. 3B (S1101) and selects one role in the selected set (S1102). Further, the role assigning section 10a selects one terminal from the terminal characteristics table shown in. FIG. 3C (S1103) and determines whether the selected terminal meets the role selection condition (S1104). When the selected terminal meets the role selection condition (Yes in S1104), the role assigning section 10a calculates the priority of the selected terminal based on the weighting set in the selection condition of the selected role (S1105). After calculating the priority of all terminals (S1106), the role assigning section 10a sorts the terminal list in the descending order of the priority and adds the terminals to the recommended terminal list shown in FIG. 14 (S1107). The calculation is performed for all roles (S1108). After performing the calculation for all sets (S1109), the role assigning section 10a transmits the recommended terminal list to the terminal that issues the request (S1110).

The priority of the terminal calculated in step S1105 is obtained as follows. The content of the selection condition is requisite, and the terminal that does not meet the condition is deleted from the terminal candidates. Further, among the selection conditions, the weighted condition is recorded as the priority of each terminal after multiplication between the score (numeral shown in parentheses in FIG. 3C) and weighting for each terminal. In the case where there are a plurality of weighted conditions, the sum of the respective priorities is set as the priority of the terminal.

As described above, according to the present invention, it is possible to assign various roles to respective terminals in accordance with their characteristics and thereby to customize the screen and input for each application in accordance with the application characteristics.

When the above operations shown in the embodiment of the present invention is stored in a computer-readable storage medium as an information processing device linkage program, it is possible to allow a computer to execute an information processing device linkage method. The computer-readable storage medium mentioned here includes: a portable storage medium such as a CD-ROM, a flexible disk, a DVD disk, a magneto-optical disk, or an IC card; a database that holds computer program; another computer and database thereof; and a transmission medium on a network line.

What is claimed is:

1. An information processing device linkage apparatus that utilizes a plurality of different terminals simultaneously to perform role sharing, comprising:
a role information acquisition section that acquires information related to a role that the terminal can take on; and
a role assigning section that assigns a combination of terminals to a predetermined role based on the information related to the role acquired by the role information acquisition section.

2. The information processing device linkage apparatus according to claim 1, further comprising
an output selection section that performs output restriction for respective terminals, to which the predetermined roles have been assigned by the role assigning section, in accordance with the assigned roles.

3. The information processing device linkage apparatus according to claim 1, wherein
the role assigning section presents, as candidates, a combination of terminals to a user and assigns a role to a combination of terminals selected by the user.

4. The information processing device linkage apparatus according to claim 3, wherein
the role assigning section provides the priority for each candidate of the terminal combination to be presented to the user.

5. The information processing device linkage apparatus according to claim 1, wherein
the role information acquisition section includes a role table storage section that sores the information related to a role as a role table, and
the role assigning section lists the terminals that suit the respective roles based on a role sharing request from an arbitrary user terminal to create a recommended terminal list and allows the user to select the terminals that take on the respective roles from the recommended terminal list.

6. The information processing device linkage apparatus according to claim 5, wherein
the role information acquisition section includes the role table storage section that stores, as the role table, information including at least one of role name, role selection condition, and role execution content that correspond to a role set, and
the role assigning section lists the terminal for each set in the role table stored in the role table storage section based on a role sharing request from an arbitrary user terminal in accordance with respective roles in decreasing order of adequacy to create the recommended terminal list and transmits the recommended terminal list to the user terminal, as well as notifies the output selection section of the content to be executed in accordance with the user's selection.

7. The information processing device linkage apparatus according to claim 5, further comprising
a terminal characteristics table storage section that stores, as a terminal characteristics table, information including at least one of screen characteristics, input device, portability, credibility, and compatibility to ancillary application that correspond to a terminal ID, wherein
the role assigning section selects one set from the role table stored in the role table storage section, selects one role from the selected set in the role table, selects one terminal from the terminal characteristics table stored in the terminal characteristics table storage section, determines whether the selected terminal meets the role selection condition, calculates the priority of the terminal based on the weighting set in the selection condition of the selected role when the selected terminal meets the role selection condition, sorts the terminal list in the descending order of adequacy so as to add the terminals to the recommended terminal list, and transmits the recommended terminal list to the terminal that has issued the role sharing request.

8. An information processing device linkage system comprising a plurality of terminals and a shared environmental server that utilizes the plurality of terminals simultaneously to perform role sharing, wherein
the shared environmental server comprises:
a role information acquisition section that acquires information related to a role that the terminal can take on; a role assigning section that assigns a combination of terminals to a predetermined role based on the information related to the role acquired by the role information acquisition section; and
an output selection section that performs output restriction for respective terminals, to which the predetermined roles have been assigned by the role assigning section, in accordance with the assigned roles, and
each of the plurality of terminals comprises:
a role sharing request section that plays the assigned role based on an instruction from the role assigning section; and
a display section that displays a restricted output from the output selection section.

9. An information processing device linkage program allowing a computer to execute an information processing device linkage method that utilizes a plurality of different terminals simultaneously to perform role sharing, comprising:
a role information acquisition step that acquires information related to a role that the terminal can take on; and
a role assigning step that assigns a combination of terminals to a predetermined role based on the information related to the role acquired in the role information acquisition step.

10. The information processing device linkage program according to claim 9, further comprising.
an output selection step that performs output restriction for respective terminals, to which the predetermined roles have been assigned in the role assigning step, in accordance with the assigned roles.

11. The information processing device linkage program according to claim 9, wherein
the role assigning step presents, as candidates, a combination of terminals to a user and assigns a role to a combination of terminals selected by the user.

12. The information processing device linkage program according to claim 11, wherein
the role assigning step provides the priority for each candidate of the terminal combination to be presented to the user.

13. The information processing device linkage program according to claim 9, wherein
the role information acquisition step acquires role information from a role table storage section that sores the information related to a role as a role table, and
the role assigning step lists the terminals that suits the respective roles based on a role sharing request from an arbitrary user terminal to create a recommended terminal list and allows the user to select the terminals that take on the respective roles from the recommended terminal list.

14. The information processing device linkage program according to claim 13, wherein
the role information acquisition step acquires the role information from the role table storage section that stores, as the role table, information including at least one of role name, role selection condition, and role execution content that correspond to a role set, and
the role assigning step lists the terminal for each set in the role table stored in the role table storage section based on a role sharing request from an arbitrary user terminal in accordance with respective roles in decreasing order of adequacy to create the recommended terminal list and transmits the recommended terminal list to the user terminal, as well as notifies the output selection section of the content to be executed in accordance with the user's selection.

15. The information processing device linkage program according to claim 13, further comprising
a terminal characteristics selection acquisition step that selectively acquires terminal characteristics from a terminal characteristics table storage section that stores, as a terminal characteristics table, information including at least one of screen characteristics, input device, portability, credibility, and compatibility to ancillary application that correspond to a terminal ID, wherein
the role assigning step selects one set from the role table stored in the role table storage section by the role information acquisition step, selects one role from the selected set in the role table, selects one terminal from the terminal characteristics table stored in the terminal characteristics table storage section by the terminal characteristics selection acquisition step, determines whether the selected terminal meets the role selection condition, calculates the priority of the terminal based on the weighting set in the selection condition of the selected role when the selected terminal meets the role selection condition, sorts the terminal list in the descending order of adequacy so as to add the terminals to the recommended terminal list, and transmits the recommended terminal list to the terminal that has issued the role sharing request.
